(19) United States
(12) Patent Application Publication
(10) Pub. No.: US 2026/0269463 A1
(43) Pub. Date: Sep. 10, 2026

(54) TRI-BAND ANTENNA COMPONENT FOR AN ELECTRONIC DEVICE

(71) Applicant: GoPro, Inc., San Mateo, CA (US)

(72) Inventors: Roger Allen Bremer, San Mateo, CA (US); Milan Velimir Lukic, San Mateo, CA (US)

(21) Appl. No.: 19/073,410

(22) Filed: Mar. 7, 2025

(51) Int. Cl. H01Q 1/36; H01Q 5/20; H01Q 5/307

(52) U.S. Cl. CPC H01Q 1/36; H01Q 5/20; H01Q 5/307

(57) ABSTRACT

An antenna component for use with an electronic device having a housing includes a conductive sheet with a main body configured to operate as a first radiator at a first frequency. A first cutout in the main body defines a first arm configured to operate as a second radiator at a second frequency. A second cutout in the main body defines a second arm configured to operate as a third radiator at a third frequency. The first cutout comprises a notch portion and a slot portion, while the second cutout comprises a first slot portion and a second slot portion. A tab extends from the first arm and is configured to engage a grounding structure of the housing. A feed contact is disposed on a surface of the main body and is configured to couple with a corresponding contact on a printed circuit board disposed within the housing.

### TECHNICAL FIELD

This disclosure relates to an antenna system, and more specifically, to an antenna component configured for use with an electronic device having a housing.

### BACKGROUND

Electronic devices such as image capture apparatuses, recording devices, sampling devices, and/or other devices that can be carried and/or worn by a user often are manufactured according to a form factor. Some electronic devices have metal housings and small form factors that can make antenna placement challenging, particularly in the case of WiFi antennas configured for communicating using three frequency bands.

### SUMMARY

Disclosed herein are implementations of an antenna component configured for use with an electronic device having a housing. The antenna component includes a conductive sheet having a main body configured to operate as a first radiator at a first frequency, a first cutout in the main body defining a first arm configured to operate as a second radiator at a second frequency, and a second cutout in the main body defining a second arm configured to operate as a third radiator at a third frequency.

Disclosed herein are implementations of an antenna component configured for use with an electronic device having a housing. The antenna component includes a conductive sheet having a main body configured to operate as a first radiator at a first frequency, a first cutout in the main body defining a first arm configured to operate as a second radiator at a second frequency, a tab extending from the first arm and configured to engage a grounding structure of the housing, and a second cutout in the main body defining a second arm configured to operate as a third radiator at a third frequency.

Disclosed herein are implementations of an electronic device. The electronic device includes a housing, a printed circuit board (PCB) disposed within the housing, and an antenna component disposed along an inside edge of the housing. The antenna component includes a conductive sheet having a main body configured to operate as a first radiator at a first frequency, a feed contact disposed on a surface of the main body and configured to couple with a corresponding contact on the PCB, a first cutout in the main body defining a first arm configured to operate as a second radiator at a second frequency, and a second cutout in the main body defining a second arm configured to operate as a third radiator at a third frequency.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIG. 6A is a rear perspective view of a portion of an electronic device, showing a housing and an antenna component.

FIGS. 6B and 6C are zoomed-in perspective views of the portion of the housing showing the antenna element of FIG. 6A.

FIG. 7A is a left perspective view of an antenna component.

FIG. 7B is a left side view of the antenna component of FIG. 7A and a clip for structurally and electrically connecting the antenna component to a printed circuit board of an electronic device.

FIG. 7C is a right side view of the antenna component of FIG. 7A.

FIG. 7D is a front view of the antenna component of FIG. 7A.

FIG. 7E is a top view of the antenna component of FIG. 7A.

### DETAILED DESCRIPTION

Various implementations described herein include an antenna component for use with an electronic device having a metal housing. The antenna component may include a conductive sheet having a main body configured to operate as a first radiator at a first frequency, a first cutout in the main body defining a first arm configured to operate as a second radiator at a second frequency, and a second cutout in the main body defining a second arm configured to operate as a third radiator at a third frequency.

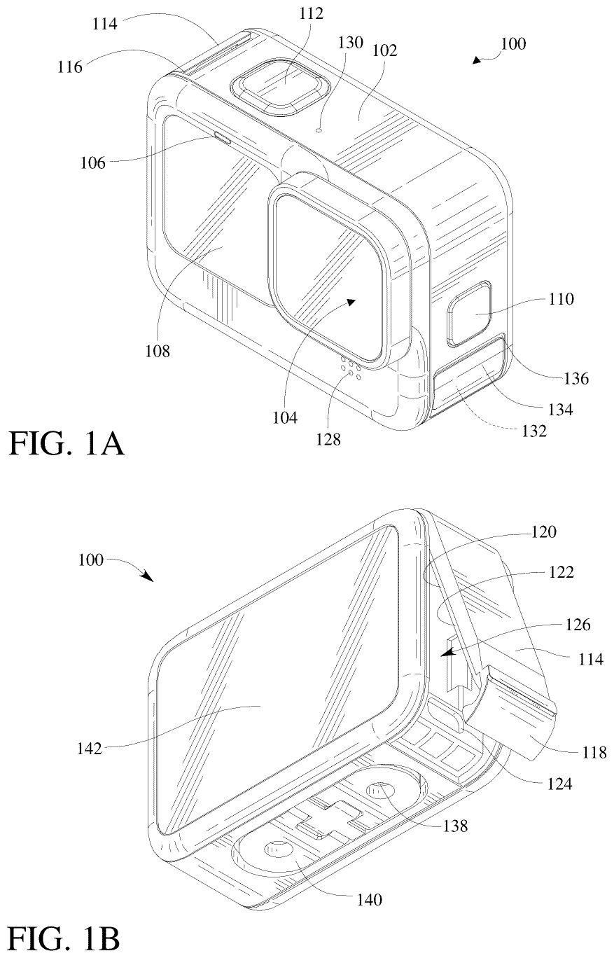

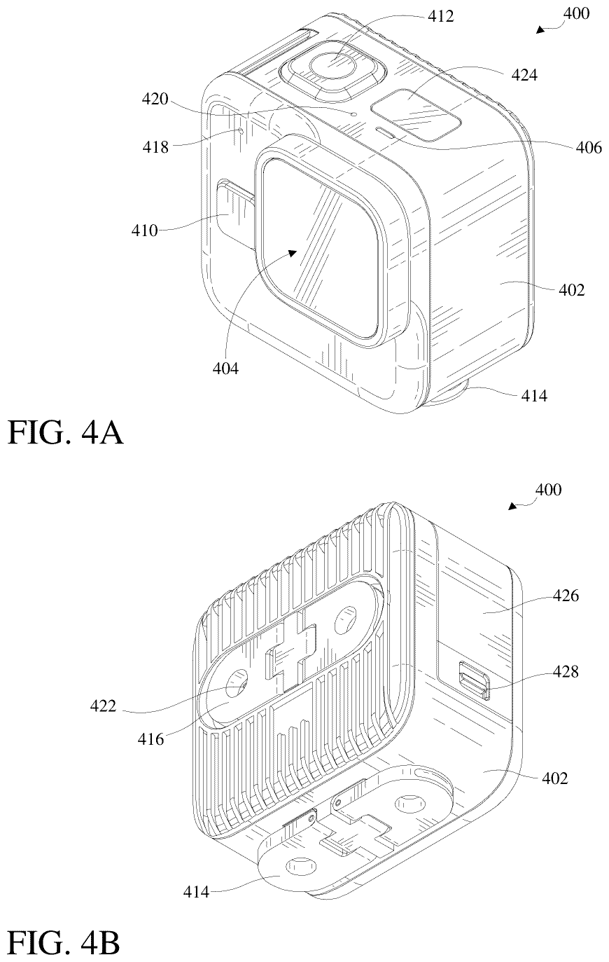

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 4. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

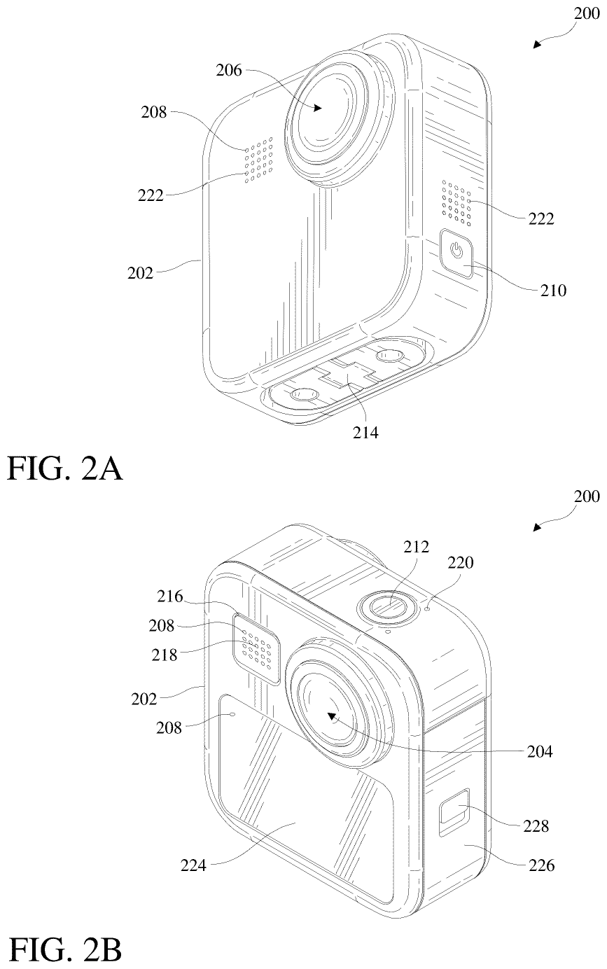

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

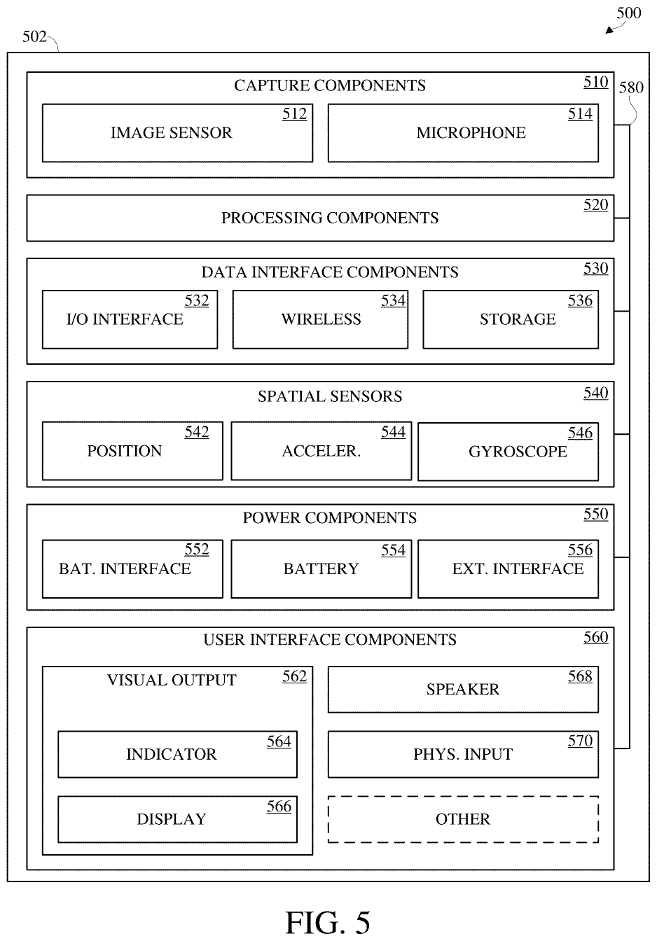

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

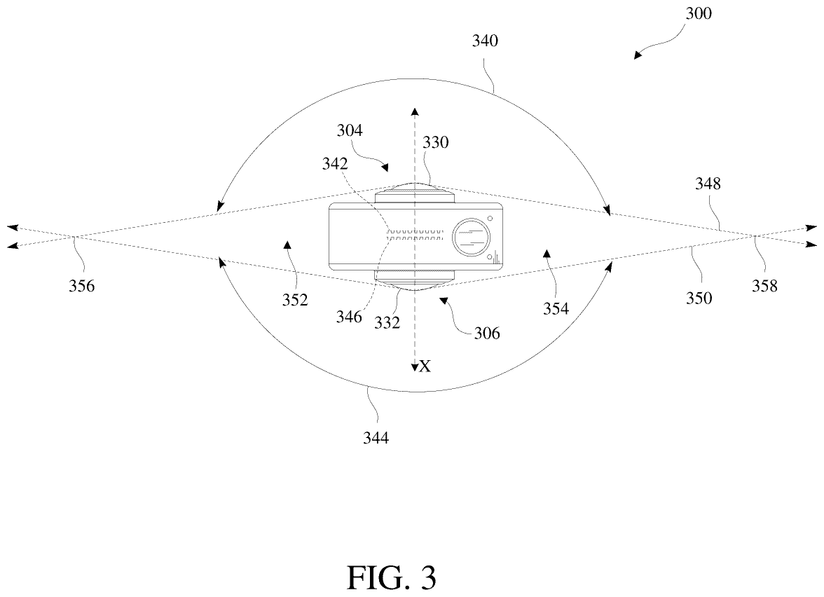

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIG. 4A, the image capture apparatus 400 may include other indictors structured on respective surfaces of the body 402.

As shown in FIG. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicate with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B. In some implementations, the wireless data interface 534 may include one or more transceivers coupled with one or more antennas. The wireless data interface 534 may be configured to facilitate 1×1 tri-band single input single output (SISO) communications with a Wi-Fi network. For example, the wireless data interface 534 may be configured to facilitate communications on a 2.4 GHz band, communications on a 5 GHz band, and communications on a 6 GHz band.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

In some implementations, an electronic device such as an image capture apparatus (e.g., the image capture apparatus 300, the image capture apparatus 200, and/or the image capture apparatus 100) may include, within its body, a metal housing and a wireless data interface including one or more transceivers coupled with one or more antennas. The one or more antennas may be configured to facilitate 1×1 SISO tri-band Wi-Fi communications. The one or more antennas may be configured to fit within a form factor of the electronic device.

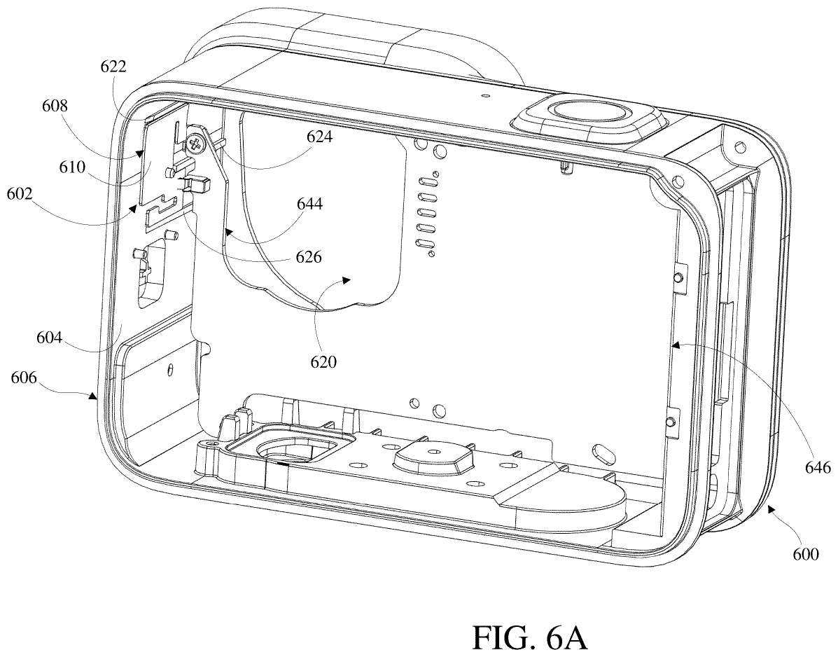

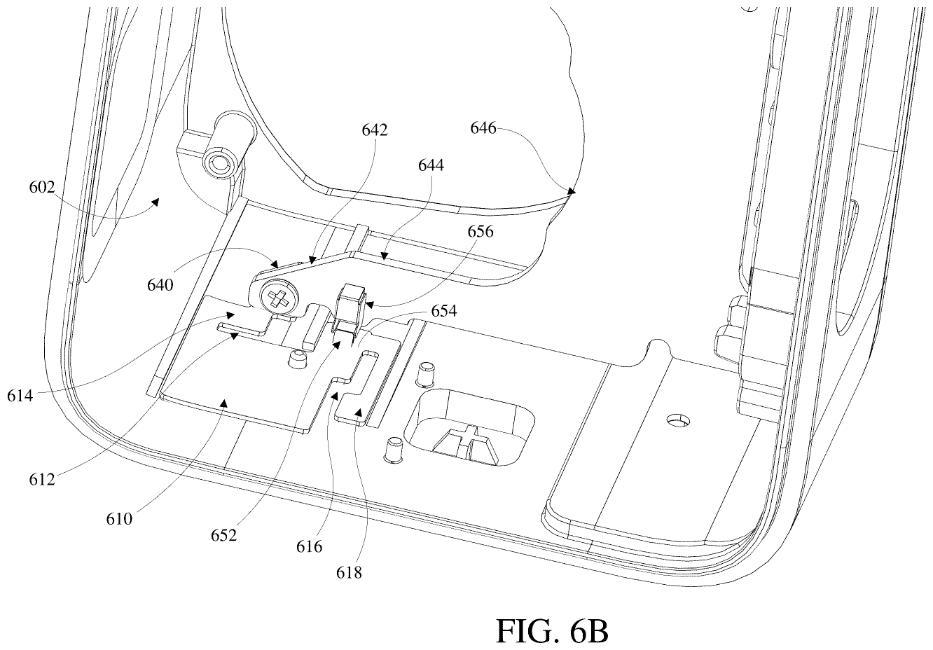

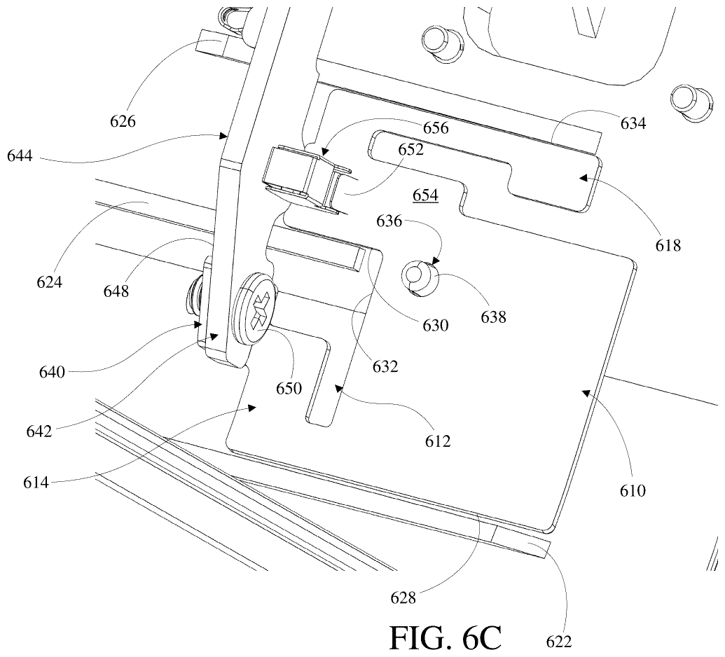

FIGS. 6A-6C include various views of an example of an electronic device having a housing 600 and an antenna component 602. FIG. 6A is a rear perspective view of a portion of the electronic device, showing the housing 600 and the antenna component 602. FIGS. 6B and 6C are zoomed-in, partial, rear-perspective views of a portion of the housing 600 including the antenna component 602. The electronic device may be, be similar to, include, or be included in the image capture apparatus 500 shown in FIG. 5, the image capture apparatus 400 shown in FIGS. 4A and 4B, the image capture apparatus 300 shown in FIG. 3, the image capture apparatus 200 shown in FIGS. 2A and 2B, and/or the image capture apparatus 100 shown in FIGS. 1A and 1B. In some implementations, the housing 600 may be a metal housing.

As shown in FIGS. 6A-6C, the antenna component 602 is configured to be disposed adjacent to an inside surface 604 of a side 606 of the housing 600. The antenna component 602 includes a conductive sheet 608 having a main body 610 configured to operate as a first radiator at a first frequency. A first cutout 612 in the main body 610 defines a first arm 614 configured to operate as a second radiator at a second frequency. A second cutout 616 in the main body 610 defines a second arm 618 configured to operate as a third radiator at a third frequency.

As shown in FIG. 6A, the antenna component 602 may be disposed along the side 606 and behind an aperture 620 configured for receiving an image capture device of the electronic component. In some implementations, positioning ribs 622, 624, and 626 may extend in a rearward direction along the inside surface 604 of the side 606. The positioning ribs 622, 624, and 626 may be configured to facilitate positioning the antenna component 602 within the housing 600. For example, as shown in FIG. 6C, the positioning rib 622 may be configured to engage (or otherwise act as a guide for) a top edge 628 of the antenna component 602. The positioning rib 624 may be configured to engage (or otherwise act as a guide for) a first inside edge 630 of the first cutout 612 and/or a second inside edge 632 of the first cutout 612. The positioning rib 626 may be configured to engage (or otherwise act as a guide for) a bottom edge 634 of the antenna component 602. The antenna component 602 may include an aperture 636 defined through the main body 610 and configured to receive a positioning post 638 therethrough to facilitate positioning of the antenna component 602 within the housing 600.

As shown in FIG. 6C, the antenna component 602 includes a tab 640 extending from the first arm 614. The tab 640 is configured to engage a grounding structure 642 of the housing 600. In some implementations, as shown in FIGS. 6A and 6B, the grounding structure 642 may be a portion of an arm 644 of a printed circuit board (PCB) 646 disposed within the housing 600. As shown in FIG. 6C, the tab 640 may engage a front surface 648 of the grounding structure 642 and may be secured in place by a fastener 650 (e.g., a screw or other fastener). A feed contact 652 may be disposed on a surface 654 of the main body 610 and may be configured to couple with a corresponding contact 656 disposed on the arm 644 of the PCB 646. The feed contact 652 may include a conductive tab or other structure configured to engage the corresponding contact 656. The contact 656 may include, as shown, a clip that may be configured as a spring clip or a quick release clip, among other examples.

The feed contact 652 may be configured to receive energy from the PCB 646 to be radiated by the antenna component 602. The energy may generally disperse throughout the antenna component 602 in various directions, causing radiation thereof by the main body 610 at a first frequency (e.g., at around 2.4 GHz), radiation by the first arm 614 at a second frequency (e.g., at around 5 GHz), and radiation by the second arm 618 at a third frequency (e.g., at around 6-7 GHz). At least some of the energy received via the feed contact 652 may travel to the grounding structure 642 via the tab 640.

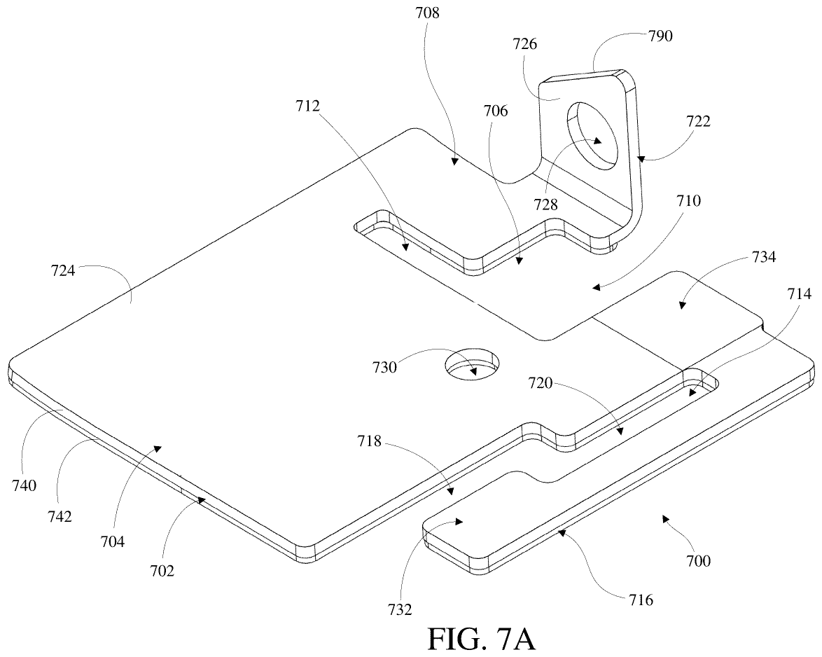

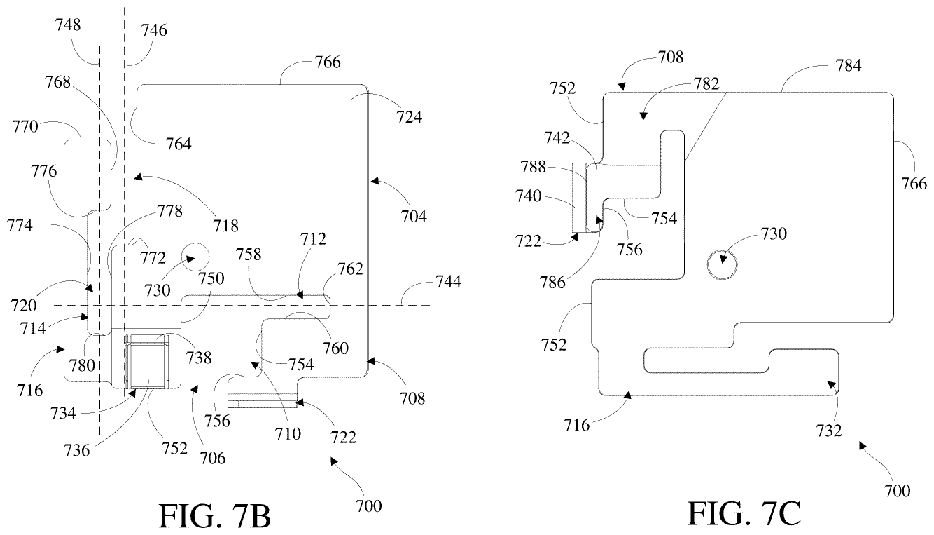

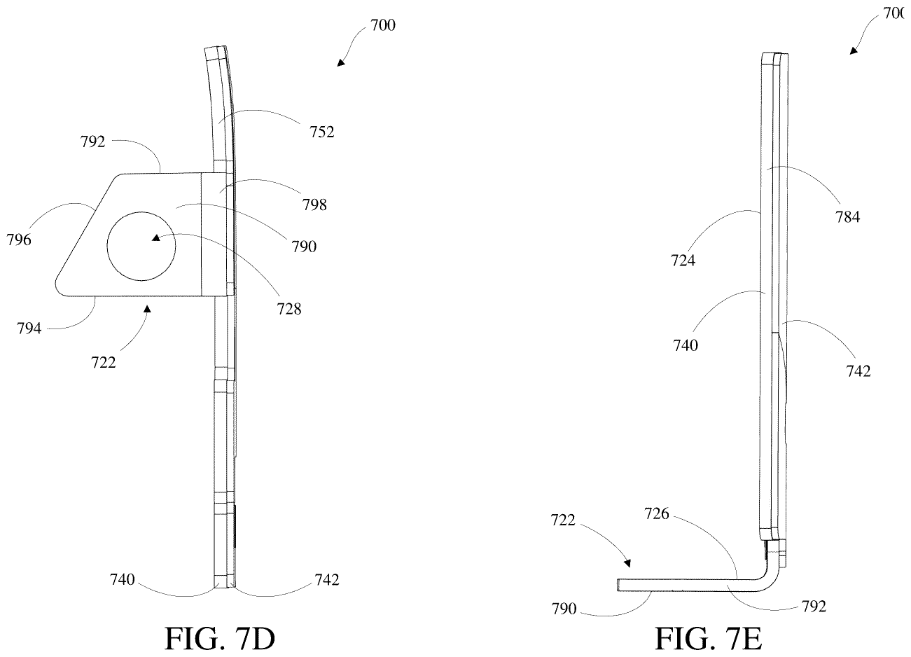

FIGS. 7A-7E are diagrams showing various views of an antenna component 700 for use within a housing, such as within a housing of an electronic device. The antenna component 700 may be, be similar to, include, or be included in the antenna component 602 shown in FIGS. 6A-6C. For example, FIG. 7A is a left perspective view of the antenna component 700, FIG. 7B is a left side view of the antenna component 700, FIG. 7C is a right side view of the antenna component 700, FIG. 7D is a front view of the antenna component 700, and FIG. 7E is a top view of the antenna component 700.

As shown in FIG. 7A, the antenna component 700 includes a conductive sheet 702 having a main body 704 configured to operate as a first radiator at a first frequency. The main body 704 may be configured to operate as a first radiator at various frequencies, which may include, but are not limited to, approximately 2.4 gigahertz (GHz), 2.45 GHz, or 2.5 GHz. In some implementations, the first frequency may be within a range of about 2.3 GHz to 2.6 GHz.

The main body 704 includes a first cutout 706 that defines a first arm 708 configured to operate as a second radiator at a second frequency. The first arm 708 may be configured to operate as a second radiator at frequencies that may include, but are not limited to, approximately 5 GHz, 5.2 GHz, 5.5 GHz, or 5.8 GHz. In some cases, the second frequency may be within a range of about 4.9 GHz to 5.9 GHz.

The first cutout 706 includes a notch portion 710 and a slot portion 712. The first cutout 706 includes a notch portion 710 and a slot portion 712. The first cutout 706 may have a complex shape that combines the notch portion 710 and the slot portion 712. The notch portion 710 may have a generally rectangular or square shape extending inward from an edge of the main body 704. In some implementations, the notch portion 710 may have rounded corners or a slightly trapezoidal shape to tune the antenna's performance. The slot portion 712 may extend from the notch portion 710, creating an elongated opening within the main body 704. In some cases, the slot portion 712 may have a narrow, elongated shape that extends from a corner or side of the notch portion 710. The slot portion 712 may be straight, curved, or have a meandering path to adjust the electrical length of the first arm 708. The combination of the notch portion 710 and slot portion 712 may create a generally L-shaped, T-shaped, or F-shaped cutout, depending on their relative sizes and positions.

The dimensions and precise geometry of the first cutout 706, including the notch portion 710 and slot portion 712, may be adjusted to fine-tune the antenna's performance characteristics, such as resonant frequency, bandwidth, and radiation pattern. In some implementations, the edges of the cutout may be chamfered or filleted to reduce electromagnetic edge effects and improve manufacturing tolerances.

A second cutout 714 in the main body 704 defines a second arm 716 configured to operate as a third radiator at a third frequency. In some implementations, the third frequency may be at least approximately 6 GHz. In some implementations, the third frequency may include frequencies such as 7 GHz, 7.5 GHz, or within a range of about 6.8 GHz to 7.8 GHz. The second cutout 714 includes a first slot portion 718 and a second slot portion 720. In some implementations, the first cutout 706 and the second cutout 714 are configured to facilitate a tri-band SISO communication capability of the antenna component 700.

The second cutout 714 may have a complex shape that combines the first slot portion 718 and the second slot portion 720. The first slot portion 718 may have an elongated shape extending from an edge of the main body 704 towards its center. In some cases, the first slot portion 718 may have a straight, curved, or meandering path to adjust the electrical length of the second arm 716. The second slot portion 720 may extend from the first slot portion 718, creating an additional opening within the main body 704. The second slot portion 720 may have a shape that is perpendicular, angled, or curved relative to the first slot portion 718. The combination of the first slot portion 718 and second slot portion 720 may create various shapes such as an L-shape, T-shape, or Y-shape, depending on their relative sizes and positions.

A tab 722 extends from the main body 704 at approximately a right angle to a right surface 724 of the main body 704. The tab 722 is configured to engage a grounding structure of the housing. The tab 722 includes a rear surface 726 configured to engage a front surface of the grounding structure. The tab 722 includes an aperture 728 defined therethrough and configured to receive a fastener for fastening the tab (and, thus, the antenna component 700) to the grounding structure. As shown, the main body 704 includes another aperture 730 near the first cutout 706 and configured to receive a positioning post therethrough.

A pad portion 732 is defined in the second arm 716 and may be configured to enhance radiation, by the second arm 716, at the third frequency. A contact area 734 is disposed between the main body 704 and the second arm 716 and is configured to couple with a PCB for receiving energy therefrom. The contact area 734 may serve as a feed contact disposed on a surface of the main body 704 and configured to couple with a corresponding contact on the PCB disposed within the housing. As shown in FIGS. 7B and 7C, the contact area 734 may be configured to be communicatively coupled with a clip 736 via an engagement portion 738 (e.g., a tab, a flange, an adhesive interface, a bonding interface, etc.).

In some implementations, the contact area 734 may be communicatively coupled with the clip 736 through various alternative mechanisms. For example, the contact area 734 may include a spring-loaded pin or pogo pin that makes contact with a corresponding pad on the clip 736. This arrangement may allow for reliable electrical connection even with slight variations in positioning or assembly tolerances. In other cases, the contact area 734 may feature a series of conductive bumps or protrusions that align with matching recesses or contact points on the clip 736. This configuration may provide multiple points of contact, potentially improving the reliability of the electrical connection.

The contact area 734 may also be designed with a flexible conductive material or elastomeric connector that conforms to the surface of the clip 736, ensuring consistent contact across a wider area. This approach may be particularly useful in situations where vibration or movement could affect the connection stability. In some implementations, the contact area 734 and clip 736 may utilize a magnetic coupling system, where conductive surfaces are held in place by magnetic force. This method may allow for easy assembly and disassembly while maintaining a secure electrical connection.

The contact area 734 may also incorporate a zero insertion force (ZIF) connector that mates with a corresponding socket on the clip 736. This type of connection may allow for easy installation and removal of the antenna component without applying significant force, which may be beneficial for manufacturing and servicing processes. In certain cases, the contact area 734 may feature a sliding or wiping contact mechanism that engages with the clip 736 as the antenna component is installed into the device housing. This sliding action may help to clean the contact surfaces and ensure a good electrical connection.

As shown, in FIGS. 7A, 7C, 7D, and 7E, the conductive sheet 702 may include a first layer 740 and a second layer 742. In some implementations, the conductive sheet 702 may be made from a single layer or more than two layers. In some implementations, the first layer 740 may be conductive and the second layer 742 may be non-conductive.

The antenna component, as illustrated in FIG. 7B, includes a first cutout 706 and a second cutout 714, each defining uniquely shaped slots and notches that contribute to the antenna's multi-band functionality. The slot portion 712 of the first cutout 706 is aligned along a first axis 744, while the first slot portion 718 of the second cutout 714 is positioned along a second axis 746, perpendicular to the first axis. The second slot portion 720 of the second cutout 714 is arranged along a third axis 748, which is parallel to the second axis. The first cutout 706 comprises a notch portion 710 and a slot portion 712. The notch portion 710 is configured as a rectangular or square indentation extending inward from the edge of the antenna component body, while the slot portion 712 extends from the notch to form a narrow, elongated opening. Together, these features create a step-like or L-shaped structure that adjusts the antenna component's current path and enhances its resonance characteristics.

The second cutout 714 consists of two slot portions that further refine the antenna component's operational frequencies. The first slot portion 718 extends forward from the rear of the antenna, forming a horizontal rectangular cut, while the second slot portion 720 extends perpendicularly upward, giving the cutout an inverted L-shape or a hook-like profile. The perpendicular slot orientations facilitate radiation at different frequency bands while minimizing interference. The shape and placement of these cutouts are designed to support tri-band functionality, enabling the antenna component to efficiently operate at a lower frequency band, such as 2.4 GHz, while also supporting higher frequency bands, such as 5 GHz and 6-7 GHz.

The compact and integrated design of the cutouts allows for efficient space utilization, making it possible to fit the antenna component within the constrained internal volume of an electronic device while maintaining high radiation efficiency. This design may eliminate a need for multiple separate antennas, consolidating multiple frequency functions into a single structure. Additionally, the tab 722 extending from the antenna engages a grounding structure, such as a portion of the device's PCB, ensuring a stable electrical connection that enhances performance by reducing signal reflection and improving impedance matching. The inclusion of alignment ribs, positioning posts, and mounting apertures facilitates precise placement of the antenna component within the housing, contributing to mechanical stability and streamlined manufacturing.

The combination of these uniquely shaped features results in an antenna component that is optimized for wireless communication in compact, metal-housed electronic devices, particularly in applications requiring robust Wi-Fi performance across multiple bands. By integrating these cutout geometries, the antenna component maximizes radiation efficiency while maintaining a form factor suitable for modern electronic device housings.

As shown in FIG. 7B, the slot portion 712 of the first cutout 706 may be oriented along a first axis 744. The first slot portion 718 of the second cutout 714 may be oriented along a second axis 746 that may be perpendicular to the first axis 744. The second slot portion 720 of the second cutout 714 may be oriented along a third axis 748 that may be parallel to the second axis 746.

The notch portion 710 of the first cutout 706 may be defined, for example, by a first inside edge 750. The first inside edge 750 may be oriented perpendicular to the first axis 744 and may extend in a rearward direction, perpendicularly away from a front edge 752 of the main body 704. The notch portion 710 may be further defined by a second inside edge 754 that is parallel and opposed to the first inside edge 750, a third inside edge 756 extending in a forward direction perpendicularly away from the second inside edge 754, and a portion of a fourth inside edge 758 extending perpendicularly away from a rear end of the first inside edge 750 (and, thus, parallel and opposed to the third inside edge 756. The slot portion 712 of the first cutout 706 may be defined by a portion of the first inside edge 750, a portion of the fourth inside edge 758, a fifth inside edge 760 extending in an upward direction perpendicularly away from a rear end of the second inside edge 754 (and, thus, parallel and opposed to the fourth inside edge 758), and a sixth inside edge 762 extending perpendicularly between an upper end of the fourth inside edge 758 and an upper end of the fifth inside edge 760 (and, thus, parallel and opposed to the first inside edge 750).

The first slot portion 718 of the second cutout 714 may be defined by a seventh inside edge 764 extending in a forward direction perpendicularly away from a lower end of a rear edge 766 of the main body 704. The first slot portion 718 may be further defined by an eighth inside edge 768 extending in a forward direction perpendicularly away from an upper end of a rear edge portion 770 of the second arm 716 (and, thus, parallel and opposed to the seventh inside edge 764). The first slot portion 718 may be further defined by a ninth inside edge 772 extending in a downward direction perpendicularly away from a forward end of the seventh inside edge 764.

The second slot portion 720 of the second cutout 714 may be defined by a tenth inside edge 774 that is parallel and opposed to the seventh inside edge 764, and an eleventh inside edge 776 that extends in an upward direction perpendicularly away from a rear end of the tenth inside edge 774. The second slot portion 720 may be further defined by a twelfth inside edge 778 that extends in a forward direction perpendicularly away from a lower end of the ninth inside edge 772 (and, thus, is parallel and opposed to the tenth inside edge 774). The second slot portion 720 may be further defined by a thirteenth inside edge 780 that extends perpendicularly between a forward end of the twelfth inside edge 778 and a forward end of the tenth inside edge (and, thus, is parallel and opposed to the eleventh inside edge 776).

As shown in FIG. 7C, the first arm 708 may include a first arm portion 782 defined between a top edge 784 of the main body 704 and the second inside edge 754. The first arm 708 may include a second arm portion 786 defined between a front edge portion 788 and the third inside edge 756. The first arm portion 782 and the second arm portion 786 may be designed to be offset from one another so as to further facilitate radiation, by the first arm portion 782 at the second frequency.

As shown in FIGS. 7D and 7E, the tab 722 may include a front surface 790 extending between an upper edge 792 and a parallel lower edge 794, and between a right edge 796 and an arcuate left edge 798. In some implementations, the right edge 796 of the tab 722 may be configured to be disposed flush adjacent an edge of the grounding structure of the PCB, as shown, for example, in FIG. 6A.

In some implementations, the antenna component 700 may be configured for use with an electronic device comprising an image capture apparatus such as, for example, the image capture apparatus 100, the image capture apparatus 200, the image capture apparatus 300, or the image capture apparatus 400. The housing of the electronic device may comprise a metal housing. The antenna component 700 may be disposed along an inside edge of the housing.

Alternative embodiments of the antenna component 700 may include variations in the shape, size, or positioning of the first cutout 706 and second cutout 714. For example, the notch portion 710 and slot portion 712 of the first cutout 706 may have different dimensions or geometries to tune the second frequency. Similarly, the first slot portion 718 and second slot portion 720 of the second cutout 714 may be modified to adjust the third frequency.

In some implementations, the tab 722 may have a different shape or extend from a different location on the main body 704. The positioning and dimensions of the apertures 728 and 730 may also vary to accommodate different mounting configurations within the housing.

The pad portion 732 and contact area 734 may be designed in various ways to ensure proper coupling with the PCB 646. For example, the contact area 734 may include conductive pads, spring contacts, or other types of electrical connectors.

The overall shape and dimensions of the antenna component 700 may be adjusted to fit within different housing designs while maintaining its tri-band radiation capabilities. This may include modifying the curvature of certain edges or surfaces, modifying the relative orientation between edges, or adjusting the relative sizes of the main body 704, first arm 708, and second arm 716. Accordingly, as used herein, the terms “perpendicular” and “perpendicularly” may include perpendicular relative orientations or relative orientations that are approximately perpendicular. Similarly, the term “parallel” may refer to relative orientations that are parallel or approximately parallel. In these contexts, the term “approximately” refers to a measure that is within a tolerance level selected so that the corresponding aspects of the antenna component function as described herein.

In some implementations, additional cutouts or conductive elements may be incorporated into the antenna component 700 to further enhance its performance or add additional frequency bands. The materials used for the conductive sheet 702, or the thicknesses of the first layer 740 or second layer 742 may also be varied to optimize the antenna's performance characteristics.

The antenna component 700, as described, provides a compact and efficient solution for enabling tri-band SISO communication capabilities in electronic devices with metal housings, such as image capture apparatuses. Its design allows for effective radiation at multiple frequencies while conforming to the spatial constraints of the device housing.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An antenna component configured for use with an electronic device having a housing, the antenna component comprising:
a conductive sheet having a main body configured to operate as a first radiator at a first frequency;
a first cutout in the main body defining a first arm configured to operate as a second radiator at a second frequency; and
a second cutout in the main body defining a second arm configured to operate as a third radiator at a third frequency.

2. The antenna component of claim 1, wherein the electronic device comprises an image capture apparatus.

3. The antenna component of claim 1, wherein the housing comprises a metal housing.

4. The antenna component of claim 1, wherein the first cutout comprises a notch portion and a slot portion.

5. The antenna component of claim 1, wherein the second cutout comprises a first slot portion and a second slot portion.

6. The antenna component of claim 1, wherein the first cutout and the second cutout are configured to facilitate a tri-band single input single output (SISO) communication capability of the antenna component.

7. The antenna component of claim 1, further comprising a tab extending from the first arm and configured to engage a grounding structure of the housing.

8. The antenna component of claim 1, further comprising a feed contact disposed on a surface of the main body and configured to couple with a corresponding contact on a printed circuit board (PCB) disposed within the housing.

9. The antenna component of claim 1, wherein the first frequency is at least approximately 2.4 gigahertz (GHz), the second frequency is at least approximately 5 GHz, and the third frequency is at least approximately 6 GHz.

10. An antenna component configured for use within a housing of an electronic device, the antenna component comprising:
a conductive sheet having a main body configured to operate as a first radiator at a first frequency;
a first cutout in the main body defining a first arm configured to operate as a second radiator at a second frequency;
a tab extending from the first arm and configured to engage a grounding structure of the housing; and
a second cutout in the main body defining a second arm configured to operate as a third radiator at a third frequency.

11. The antenna component of claim 10, wherein the first cutout comprises a notch portion and a slot portion.

12. The antenna component of claim 10, wherein the second cutout comprises a first slot portion and a second slot portion.

13. The antenna component of claim 10, wherein the first cutout and the second cutout are configured to facilitate a tri-band single input single output (SISO) communication capability of the antenna component.

14. The antenna component of claim 10, further comprising a feed contact disposed on a surface of the main body and configured to couple with a corresponding contact on a printed circuit board (PCB) disposed within the housing.

15. The antenna component of claim 10, wherein the first frequency is at least approximately 2.4 gigahertz (GHz), the second frequency is at least approximately 5 GHz, and the third frequency is at least approximately 6 GHz.

16. An electronic device, comprising:
a housing;
a printed circuit board (PCB) disposed within the housing; and
an antenna component disposed along an inside edge of the housing, the antenna component comprising:
a conductive sheet having a main body configured to operate as a first radiator at a first frequency;
a feed contact disposed on a surface of the main body and configured to couple with a corresponding contact on the PCB;
a first cutout in the main body defining a first arm configured to operate as a second radiator at a second frequency; and
a second cutout in the main body defining a second arm configured to operate as a third radiator at a third frequency.

17. The electronic device of claim 16, wherein the first cutout comprises a notch portion and a slot portion.

18. The electronic device of claim 16, wherein the second cutout comprises a first slot portion and a second slot portion.

19. The electronic device of claim 16, further comprising a tab extending from the first arm and configured to engage a grounding structure of the housing.

20. The electronic device of claim 16, wherein the first frequency is at least approximately 2.4 gigahertz (GHz), the second frequency is at least approximately 5 GHz, and the third frequency is at least approximately 6 GHz.
